(19) United States
(12) Patent Application Publication
(10) Pub. No.: US 2009/0127397 A1
(43) Pub. Date: May 21, 2009

(54) Wireless radio frequency identification impact cargo parachute automatic release system

(76) Inventors: Bevan Hyunh, Seminole, FL (US); Thien-Bach Brian Huynh, Seminole, FL (US)

Correspondence Address: Bevan Huynh, 5917 Hillside street, Seminole, FL, 33772, US

(21) Appl. No.: 12/291,311

(22) Filed: Nov. 7, 2008

Related U.S. Application Data
(60) Provisional application No. 61/002,845, filed on Nov. 13, 2007.

(51) Int. Cl. B64D 17/00

(52) U.S. Cl. 244/152

(57) ABSTRACT

The invention disclosed herein includes a parachute airdrop system and method for releasing cargo from a parachute. The system includes a locking device that connects cargo to a parachute, an impact sensor unit associated with the cargo, and a transceiver unit associated with the parachute. A controller processes signals generated by the impact sensor to determine whether threshold conditions are satisfied which indicates that the cargo has impacted a surface. When the threshold conditions are satisfied, a control signal is sent to the transceiver unit, preferably wirelessly. The transceiver unit then generates a fire control signal for firing a charge to release the locking device to thereby disconnect the parachute from the cargo.

### CLAIM OF PRIORITY

This application claims priority to U.S. Provisional Application No. 61/002,845, filed Nov. 13, 2007, entitled Wireless Radio Frequency Identification Impact Cargo Parachute Automatic Release System, which is incorporated herein in its entirety by this reference thereto.

### BACKGROUND

The United States military and other entities provide aerial delivery drops carrying heavy equipment such as trucks, weapons, water, and food using parachute airdrop operations. The military also may release water submersible vehicles from parachutes, a concept disclosed in U.S. Pat. No. 6,640,739 B2. The weight of the cargo can reach up to 50 thousand pounds. Current cargo airdrop operations using parachutes employ the M1 or the M2 parachute cargo release systems. The M1 and M2 release systems are operated on a mechanical tilt principle to release the parachute from the cargo payload after it has landed on the ground surface. The surface level wind drag force sometimes causes the parachute canopy, which remains inflated (open), to continue pulling and tipping the cargo or turning the cargo upside down, causing the cargo to crash and become damaged. Further, the M1 and M2 sometimes releases the cargo payload prematurely while the cargo parachute is still in mid-air causing damage to the payload when it impacts the ground.

### SUMMARY OF THE INVENTION

A new parachute cargo release system is needed to replace the mechanical M1 and M2 parachute release system. The new release system disclosed herein helps to reduce, minimize or eliminate the damage caused to cargo during parachute airdrop operations.

The invention disclosed herein includes a parachute airdrop system and method for releasing cargo from a parachute. The system includes a locking device that connects cargo to a parachute, an impact sensor unit associated with the cargo, and a transceiver unit associated with the parachute. A controller processes signals generated by the impact sensor to determine whether threshold conditions are satisfied which indicates that the cargo has impacted a surface. When the threshold conditions are satisfied, a control signal is sent to the transceiver unit, preferably wirelessly. The transceiver unit then generates a fire control signal for firing a charge to release the locking device to thereby disconnect the parachute from the cargo.

### BRIEF DESCRIPTION OF THE DRAWINGS

The invention is best understood by those having ordinary skill in the art by reference to the following detail description when considered in conjunction with the accompanying drawings, none of which are limiting:

FIG. 1 is schematic diagram of the Wireless Radio Frequency Impact Cargo Parachute Automatic Release System;

FIG. 2 is the schematic block diagram of the Impact Transceiver Unit;

FIG. 3 is the schematic block diagram of the Release Transceiver Unit.

### DETAIL DESCRIPTION OF THE INVENTION

Throughout the following detailed description, the same reference numerals refer to the same elements in all figures.

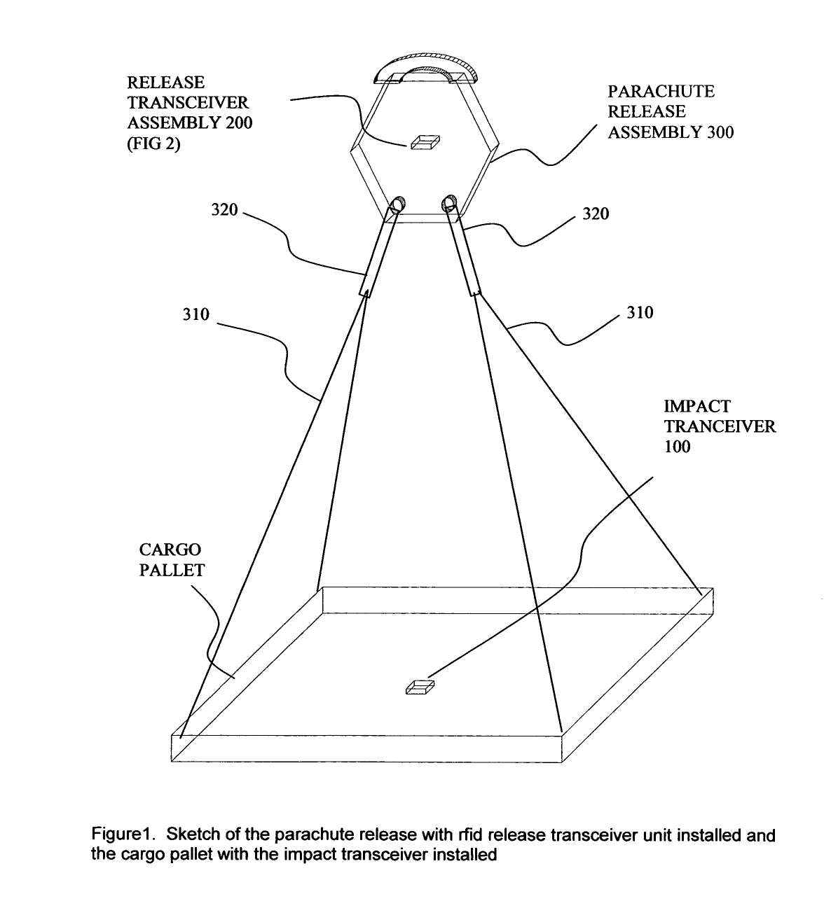

FIG. 1 illustrates a parachute airdrop system that includes an impact sensor transponder unit, also referred to as an impact transceiver unit 100, located on or mounted to the cargo or to the cargo container or the like (hereinafter referred to generally as the “cargo”), a parachute, and a parachute release device 300. The parachute includes its canopy, cords, and attachment or mounting devices (none shown). The release device 300 attaches the parachute to cargo cords 310 via a release suspension mechanism 320, which in turn is connected to the cargo, as shown in FIG. 1. Alternatively, the release suspension mechanism 320 may be connected directly to the cargo. Alternatively, the cords 310 may connect to a carrier device which carries cargo, such as a container or a pallet. The impact transceiver unit 100 may be located on the carrier device.

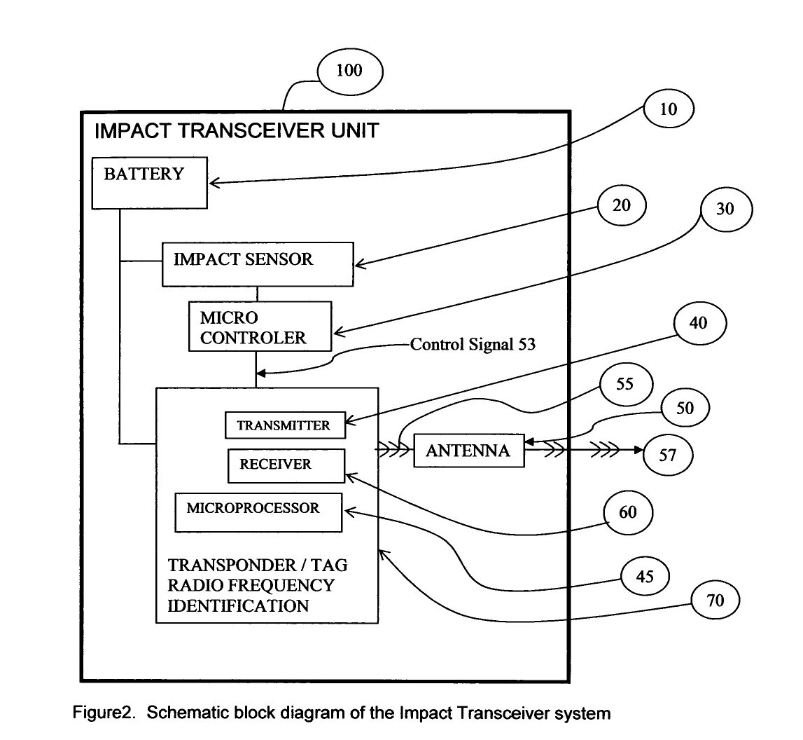

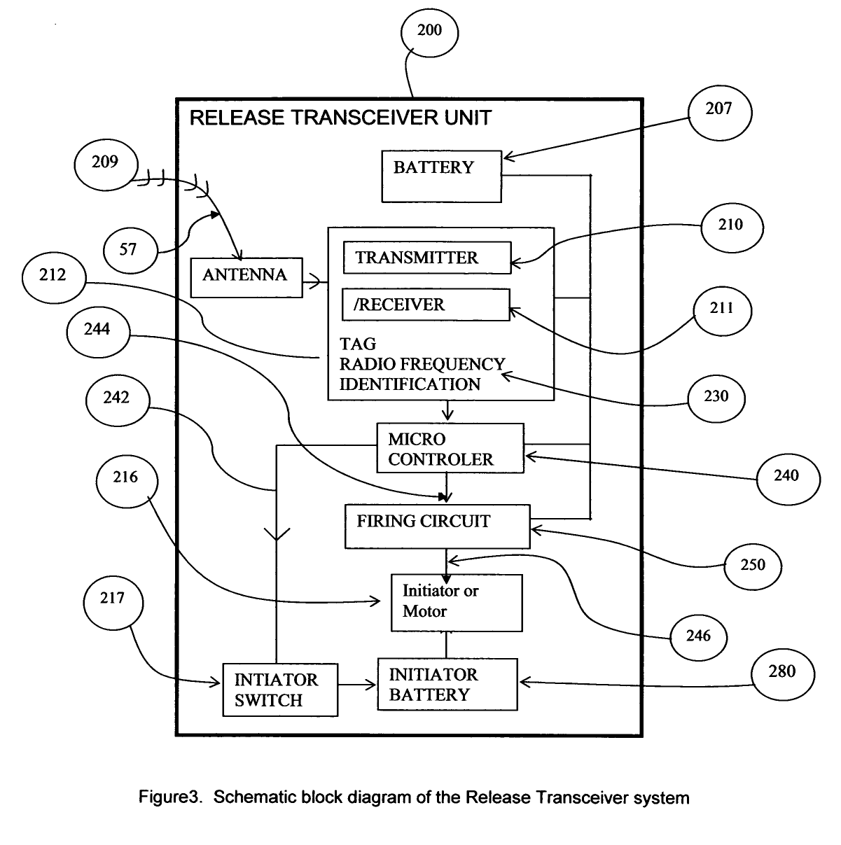

Referring to FIGS. 2 and 3, impact transceiver unit 100 may include a power source, such as, for example, battery or batteries 10, which may be part of the unit 100 itself or separate there from and located on the cargo. The battery 10 power is delivered to all of the impact transceiver unit's components that utilize power. Alternatively, power to operate the impact transceiver unit 100 may be generated from a small generator driven by wind power, or using solar power generated from solar cells.

Referring to FIG. 2, the impact transceiver unit 100 further includes an impact sensor 20 which in a conventional manner reacts to changes in physical characteristics according to its design. For example, certain impact sensors are designed to detect changes in velocity. In such a case, the changes in velocity, or impact, are converted to a signal. These signals are sent to the controller 30 as input for processing. The impact sensor 20 either alone or in combination with the controller 30 is thus able to detect the impact of the cargo pallet when it hits a surface, such as ground, a building surface, or water.

As will be understood by those of ordinary skill in the art, the controller 30 may include a programmed algorithm that outputs control signal 53 when threshold conditions are satisfied, indicating that a true impact has occurred. In this manner, the controller 30 differentiates true impacts from sudden and abrupt movements. The control signal 53 is received by the transponder 70. The transponder 70 may be, for example, a Tag Radio Frequency Identification (RFID). The transponder 70 may contain information and data on the cargo payload. The transponder 70 may include a transmitter 40, a receiver 60 and a microprocessor. The transponder 70 may contain its own microprocessor 45, or it may utilize the controller 30 for processing. Within a sufficiently short amount of time, such as, e.g., 100 milliseconds, the microprocessor 45 or controller 30 causes the transmitter 40 to output a signal 55 which is delivered to the antenna 50. Signal 55 radiates from the antenna 50 as a radio signal 57 to a sufficient range such that it is adequately received by the release transceiver unit 200, which is associated with the parachute. That is, it is located, for example, on or in the cargo parachute release 300. The signal 55 and corresponding radio signal 57 may, for example, be a unique output radio frequency identification coded signal. The range of the radio signal 57 may be programmable and adjustable through the transponder 70 and controller 30 code and electronic components. Alternatively, the impact transceiver unit 100 may be hardwired to the release transceiver unit 200 in a known manner.

The components of the impact transceiver unit 100, e.g., battery 10, impact sensor 20, controller 30, transponder 70, and antenna 57, may be housed or assembled as a single device or unit, or they may be separate devices interconnected to work together. These devices may also be housed or assembled in any combination. Although illustrated as a separate component from the impact sensor 20, the controller 30 may be part of the impact sensor 20.

Referring to FIG. 3, the release transceiver unit 200 may include a power source, such as, for example, a battery 207, a transponder 230, a controller 240, an antenna 209, a firing circuit 250, an initiator 216, an initiator battery 280, a firing device (or explosive device), and an initiator switch 217. The antenna 209 of the release transceiver 200 receives the radio signal 57 which radiates from the impact transceiver antenna 60. The radio signals 57 are received by the transponder's 230 receiver 211. The transponder 230 may also include a transmitter 210. The transponder 230 may be, for example, a Tag Radio Frequency Identification (RFID). The transponder 230 tag RFID may contain information and data on the cargo payload. The radio signals are then processes by the controller 240. Based on this processing, the controller 240 outputs a control signal 242 to the initiator switch 217 to close the switch and provide voltage from the initiator battery 280 to the initiator 216. The voltage to the initiator 216 may also be provided by the power source or battery 207.

Based on the processing of radio signals 57, the controller 240 also sends a control signal 244 to the firing circuit 250, which outputs a signal 246 to fire the initiator 216. In an alternative embodiment, the initiator may an electric motor controlled and/or operated by signal 246 output from the firing circuit 250. The initiator will thus only fire when it receives the voltage from the initiator battery 280 and the signal 246 from the firing circuit. In the alternative embodiment, the motor will thus only operate when it receives the voltage from the battery 280 and the signal 246 from the firing circuit. In a conventional manner, the initiator 216 ignites or fires a charge that quickly forces a pressure gas to the locking pin channels of the release mechanism 320. The pressure of the gas forces the locking pin to unlock the parachute cargo-release's mechanism. In the alternative embodiment, the motor operates to unlock the locking mechanism to release and free the parachute from the cargo.

The components of the release transceiver unit 100, e.g., battery 207, impact sensor 20, controller 240, transponder 230, and antenna 209, firing circuit 250, initiator 216, initiator switch 217, and initiator battery 280, may be housed or assembled as a single device or unit, or they may be separate devices interconnected to work together. These devices may also be housed or assembled in any combination. The initiator switch may be a conventional electro-mechanical switch, or alternatively may be a DSP.

The controllers and microprocessors discussed above may be any conventional controller, microcontroller, microprocessor, processor or state machine. A controller or microprocessor may also be implemented as a combination of computing devices, e.g., a combination of a DSP and a microprocessor, a plurality of microprocessors, one or more microprocessors in conjunction with a DSP core, or any other such configuration. The steps of a method or algorithm described in connection with the embodiments disclosed herein may be embodied directly in hardware, in a software or code module executed by a processor, or in a combination of the two. A code, microcode, or a software module may reside in RAM memory, flash memory, ROM memory, EPROM memory, EEPROM memory, registers, hard disk, a removable disk, a CD-ROM, a RFID tag or any other form of storage medium known in the art. The processor or microprocessor and an associated storage medium may reside in an application specific integrated circuit (ASIC).

The impact sensor 20 may be a conventional sensor, such as for example, a conventional piezo-electric impact sensor that operates in a known manner. That is, when external impact is applied to the piezo vibration plate of a piezo-electric impact sensor, the capacitance of the vibration plate is changed. In such a case, the sensor amplifies the capacitance signal and senses the external impact. However, the invention is not limited to any specific type of impact sensor, and other types of conventional sensors are contemplated, such as, e.g., a pressure sensor, a deformation sensor, and an electronic accelerometer sensor, etc.

More than one impact sensor may be used in series to provide redundancy to ensure that an actual impact to the surface has occurred, as opposed to being suddenly jarred en route.

In another embodiment, rather than using an impact sensor to detect the cargo's impact on a surface, a tension release mechanism may be used to detect lack of tension, which triggers a release of the release mechanism to detach the parachute from the cargo. Here, the tension release mechanism may become operational only upon a threshold tension existing in the mechanism. This occurs when the parachute opens on descent and the drag forces of the parachute opposes the weight of the cargo, and the resultant force is transmitted through the tension release mechanism. When the cargo impacts a surface, the tension in the tension release mechanism abruptly diminishes. This diminished force is detected by electronic sensors and controllers which output a control signal to triggers the release of the release mechanism, as discussed above. Alternatively, the diminished force can be detected by a mechanical sensor, such as a spring or cantilever mechanism, which when retracted to a certain point upon a diminishing force, triggers the release of the release mechanism. When such a mechanical sensor is used, there is no need for external power, which, for example, may be needed to operate the electronic sensors and controllers.

The RFID parachute airdrop system disclosed herein may be uniquely assigned an operating frequency for each payload airdrop operation. It may be beneficial that the system is not activated or turned on while the cargo is inside the aircraft. In such a case, the system may include a device (not shown) that is connected to an arming wire so that the system activates by the arming wire after the cargo exits the aircraft. Other arming devices known in the art may also be used.

It is evident that the embodiments disclosed will decrease or eliminate the amount of damage that occurs when cargo is dropped from aircraft due to ground level wind drag on the parachute. This will also save the de-riggers time and soldiers from potential harm.

In operation, the impact transceiver unit 100 may be mounted on the cargo payload at center of gravity or at the convenience location on the cargo or carrier. The release transceiver unit 200 is mounted on the parachute cargo release. After exiting the aircraft, the parachute canopy inflates and the cargo may, for example, descend to the surface at the rate about 25 feet per second, depending on the size of the parachute and the cargo weight. When the cargo payload impacts the surface, the impact sensor 20 of detects the impact and sends an electrical information (signal) to the microcontroller. This microcontroller determines whether threshold conditions are satisfied. When these threshold conditions are satisfied, it is an indication that true surface impact has occurred and the conditions are proper for parachute release from the cargo. From there, the transmitter transmits the impact RF signal codes through the antenna and this signal travels preferably wirelessly to the receiver of the release transceiver unit 200. The release transceiver unit, mounted on the parachute cargo release device 300, receives the impact RF signal from the impact transceiver unit. The RF signal is sent to the microcontroller for processing. The microcontroller sends a command signal to close the switch supplying power or a voltage to the initiator, or alternatively to an electric motor. The microcontroller also outputs a control signal to the firing circuit, which in turn outputs a firing control signal to the initiator to fire the explosive charge. Thus, after the initiator receives voltage and the firing circuit receives a control signal, the firing circuit activates and fires the initiator electronic explosive device, or alternatively operates a small motor. The ignition of the initiator releases a pressurized gas to a locking pin channel of the release assembly. The gas pressure of the initiator pushes the locking pins to release the lock which frees the parachute from the cargo. Alternatively, a small motor operates to release the locking mechanism to free the parachute from the cargo.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A parachute airdrop system for releasing cargo from a parachute, the system comprising:
A locking device that connects cargo to a parachute,
An impact sensor associated with the cargo, the impact sensor generating signals,
A controller for processing the signals generated by the impact sensor to determine whether threshold conditions are satisfied which indicate that the cargo has impacted a surface,
A transmitter for transmitting a control signal to a transceiver unit when the threshold conditions are satisfied,
The transceiver unit being associated with the parachute, the transceiver unit capable of generating a fire control signal, in response to the control signal, for firing a charge to release the locking device to thereby disconnect the parachute from the cargo.

2. The system of claim 1, wherein the impact sensor is located on the cargo.

3. The system of claim 1, wherein the impact sensor is located on a device that carries the cargo.

4. The system of claim 1, wherein transmitting a control signal to a transceiver unit is done wirelessly.

5. The system of claim 1, wherein the transceiver unit is located on the parachute.

6. The system of claim 1, wherein the transceiver unit is connected to the parachute.

7. The system of claim 1, wherein the impact sensor is a piezo-electric impact sensor.

8. The system of claim 1, further including a device for providing power for transmitting a control signal to the transceiver unit.

9. The system of claim 8, wherein said device for providing power is a battery.

10. The system of claim 1, wherein the controller is a microcontroller.

11. The system of claim 1, further including a tag radio frequency identification.

12. The system of claim 11, wherein the tag radio frequency identification contains information about the cargo.

13. The system of claim 1, wherein the transceiver unit further includes:
a firing circuit, an initiator, and an initiator switch, wherein
the controller outputs a control signal to the initiator switch to close the initiator switch for providing voltage from a power source to the initiator, and
the controller outputs a control signal to the firing circuit which outputs a control signal to the initiator to fire the explosive charge.

14. The system of claim 1, wherein at least two of said impact sensor, controller, and transmitter are housed in a single device.

15. The system of claim 13, wherein at least two of said firing circuit, initiator, initiator switch are housed in a single device.

16. The system of claim 1, further including a device that activates the system after the cargo exits an aircraft from which the cargo is to be dropped.

17. The system of claim 1, wherein the transceiver unit further includes:
a firing circuit, an electric motor, and an initiator switch, wherein
the controller outputs a control signal to the initiator switch to close the initiator switch for providing voltage from a power source to the electric motor, and
the controller outputs a control signal to the firing circuit which outputs a control signal to operate the electric motor to unlock the locking device to release and free the parachute from the cargo.

18. A method of releasing cargo from a parachute, the method comprising:
providing an impact sensor in association with cargo,
processing signals generated by the impact sensor to determine whether threshold conditions are satisfied which indicate that the cargo has impacted a surface,
transmitting a control signal to a transceiver unit that is associated with the parachute when the threshold conditions are satisfied,
the transceiver unit generating a fire control signal for firing a charge to release a locking device that connects the parachute to the cargo, to thereby disconnect the parachute from the cargo.

19. The method of claim 18, wherein the impact sensor is located on the cargo.

20. The method of claim 18, wherein the impact sensor is a piezo-electric impact sensor.
